(19) United States
(12) Patent Application Publication
(10) Pub. No.: US 2025/0164987 A1
(43) Pub. Date: May 22, 2025

(54) FACILITY EQUIPMENT COOPERATION SYSTEM

(71) Applicant: RINNAI CORPORATION, Nagoya-shi (JP)

(72) Inventor: Ai Yuge, Nagoya-shi (JP)

(21) Appl. No.: 18/899,026

(22) Filed: Sep. 27, 2024

(30) Foreign Application Priority Data
Nov. 20, 2023 (JP) 2023-197032

(51) Int. Cl. G05B 23/02

(52) U.S. Cl. CPC G05B 23/0275; G05B 23/027

(57) ABSTRACT

The facility equipment cooperation system includes an external server and facility equipment. The facility equipment acquires equipment information including installation place information regarding an installation place of the facility equipment, and transmits the equipment information to an external server. The external server transmits external server information including information according to an installation environment of the facility equipment to the facility equipment on the basis of the equipment information. The facility equipment updates the inspection information stored in the inspection information storage unit on the basis of the external server information. The comparison and determination unit of the facility equipment compares the updated inspection information with the usage condition information stored in the usage condition storage unit, and determines whether or not the inspection time has come.

### BACKGROUND OF THE INVENTION

### Field of the Invention

The present invention relates to a facility equipment cooperation system having a function of performing an inspection notification for evoking a component inspection of facility equipment installed in a house, a facility, or the like.

### Description of the Related Art

JP 2000-154940 A discloses, in an electric water heater that is facility equipment, a technique of preventing hot water supply from becoming impossible due to a failure by expiration of a component life by providing a warning means for warning a user that a component replacement time has come when an accumulated time of a use time of each component has exceeded a predetermined life time.

### SUMMARY OF THE INVENTION

Incidentally, a degree of deterioration of components of facility equipment installed in a house or the like such as an electric water heater varies depending on an installation environment of the facility equipment. That is, in an installation environment in which the installation place of the facility equipment is, for example, a high temperature and high humidity area, a coastal area, a high altitude area, a high hardness water area, or the like, deterioration of components of the facility equipment may be accelerated. However, since the technique described in Patent Literature 1 is a warning method based on a predetermined constant life time, there has been a possibility that the component life will end and facility equipment will fail before a warning of component replacement in an environment where the component life is shortened. Note that, in a case where the installation environment of the facility equipment is an environment friendly to the components, the component lifetime may be extended.

The present disclosure has been made in view of the above circumstances, and an object of the present disclosure is to provide a facility equipment cooperation system capable of performing inspection notification at an appropriate time according to an installation environment of facility equipment.

A facility equipment cooperation system according to the present disclosure 1 is a facility equipment cooperation system, including:
an external server; and
facility equipment capable of communicating with the external server,
in which the external server is configured to transmit external server information including information according to an installation environment of the facility equipment to the facility equipment on a basis of equipment information transmitted from the facility equipment,
the facility equipment includes:
   an inspection information storage unit corresponding to at least one component of a plurality of components constituting the facility equipment and storing inspection information regarding execution of a predetermined inspection;
   a usage condition storage unit that stores usage condition information on a usage condition of the one component or the facility equipment;
   a comparison and determination unit that compares the inspection information stored in the inspection information storage unit with the usage condition information stored in the usage condition storage unit and determines whether or not an inspection notification time has come;
   a notification instruction unit that performs a notification instruction to a notification unit that performs an inspection notification for evoking an inspection to a user when the comparison and determination unit determines that the inspection notification time has come;
   an equipment information acquisition unit that acquires the equipment information including installation place information regarding an installation place of the facility equipment;
   an information transmission unit that transmits the equipment information acquired by the equipment information acquisition unit to the external server;
   an information reception unit that receives the external server information transmitted from the external server; and
   an information processing unit that updates the inspection information stored in the inspection information storage unit on a basis of the external server information received by the information reception unit, and
the comparison and determination unit is configured to compare, after the inspection information of the inspection information storage unit is updated, the updated inspection information with the usage condition information, and determine whether or not the inspection notification time has come.

According to the configuration of the present disclosure 1, the external server transmits the external server information including the information according to the installation environment of the facility equipment to the facility equipment on the basis of the equipment information transmitted from the facility equipment, and the facility equipment updates the inspection information stored in the inspection information storage unit on the basis of the external server information transmitted from the external server. As a result, the facility equipment can change the inspection notification time according to the installation environment of the facility equipment. Furthermore, since the facility equipment can periodically update the inspection information and review the inspection reference by communicating with the external server, it is possible to perform the inspection notification at a time reflecting the actual situation of the installation environment of the facility equipment. Therefore, even when the facility equipment is installed in an installation environment in which the life time of the component is shortened, the inspection notification can be performed at an appropriate time to the user according to the installation environment of the facility equipment. Therefore, it is possible to perform maintenance such as replacement, maintenance, and maintenance of the component at an appropriate time before the end of the component life in consideration of the installation environment of the facility equipment, and to prevent failure of the facility equipment due to the end of the component life.

A facility equipment cooperation system according to the present disclosure 2 can be configured such that, in the facility equipment cooperation system according to the present disclosure 1,
the external server includes:
   a load information collection unit that collects load-related information regarding an environment in an installation place of the facility equipment on a basis of the installation place information included in the equipment information transmitted from the facility equipment; and
   an environmental load information generation unit that generates environmental load degree information regarding evaluation of the predetermined inspection information on a basis of the load-related information collected by the load information collection unit,
the external server transmits information including the environmental load degree information to the facility equipment as the external server information,
the facility equipment includes an updated inspection information generation unit that generates updated inspection information in which the predetermined inspection information is information according to an installation environment of the facility equipment on a basis of the environmental load degree information included in the external server information received by the information reception unit, and
the information processing unit updates the inspection information stored in the inspection information storage unit to the updated inspection information.

According to the configuration of the present disclosure 2, in the external server, the load information collection unit is caused to collect the load-related information regarding the environment in the installation place of the facility equipment from the enormous data, and the environmental load information generation unit is caused to generate the environmental load degree information. Therefore, the load of the processing for the inspection notification on the facility equipment side can be reduced, and accordingly, the capacity of the microcomputer on the facility equipment side can be made relatively small, and the cost of the facility equipment can be suppressed.

A facility equipment cooperation system according to the present disclosure 3 may be configured such that, in the facility equipment cooperation system according to the present disclosure 1,
the external server includes a load information collection unit that collects load-related information regarding an environment in an installation place of the facility equipment on the basis of the installation place information included in the equipment information transmitted from the facility equipment,
the external server transmits information including the load-related information to the facility equipment as the external server information,
the facility equipment includes:
   an environmental load information generation unit that generates environmental load degree information regarding evaluation of the predetermined inspection information on the basis of the load-related information included in the external server information received by the information reception unit; and
   an updated inspection information generation unit that generates updated inspection information in which the predetermined inspection information is information according to an installation environment of the facility equipment on the basis of the environmental load degree information, and
the information processing unit updates the inspection information stored in the inspection information storage unit to the updated inspection information.

According to the configuration of the present disclosure 3, in the external server, the load information collection unit is caused to collect the load-related information regarding the environment in the installation place of the facility equipment from the enormous data. Therefore, the load of the processing for the inspection notification on the facility equipment side can be reduced, and accordingly, the capacity of the microcomputer on the facility equipment side can be made relatively small, and the cost of the facility equipment can be suppressed.

A facility equipment cooperation system according to the present disclosure 4 may be configured such that, in the facility equipment cooperation system according to the present disclosure 1,
the external server includes:
   a load information collection unit that collects load-related information regarding an environment in an installation place of the facility equipment on the basis of the installation place information included in the equipment information transmitted from the facility equipment;
   an environmental load information generation unit that generates environmental load degree information regarding evaluation of the predetermined inspection information on the basis of the load-related information collected by the load information collection unit; and
   an updated inspection information generation unit that generates updated inspection information in which the predetermined inspection information is information according to an installation environment of the facility equipment on the basis of the environmental load degree information generated by the environmental load information generation unit,
the external server transmits information including the updated inspection information to the facility equipment as the external server information, and
the information processing unit of the facility equipment updates the inspection information stored in the inspection information storage unit with the updated inspection information included in the external server information received by the information reception unit.

According to the configuration of the present disclosure 4, in the external server, the load information collection unit is caused to collect the load-related information regarding the environment in the installation place of the facility equipment from the enormous data, the environmental load information generation unit is caused to generate the environmental load degree information, and the updated inspection information generation unit is caused to generate the updated inspection information. Therefore, the load of the processing for the inspection notification on the facility equipment side can be reduced, and accordingly, the capacity of the microcomputer on the facility equipment side can be made relatively small, and the cost of the facility equipment can be suppressed.

### BRIEF DESCRIPTION OF THE DRAWINGS

FIG. 1 is a block diagram schematically illustrating an overall configuration of a facility equipment cooperation system according to a first embodiment;

FIG. 2 is a schematic diagram illustrating a configuration example of a water heater;

FIG. 3 is a table showing an example of environmental load degree information set for each environmental factor for each component;

FIG. 4 is a sequence diagram illustrating a relationship among a water heater, an external server, and another server according to the first embodiment;

FIG. 5 is a block diagram schematically illustrating an overall configuration of a facility equipment cooperation system according to a second embodiment;

FIG. 6 is a sequence diagram illustrating a relationship among a water heater, an external server, and another server according to the second embodiment;

FIG. 7 is a block diagram schematically illustrating an overall configuration of a facility equipment cooperation system according to a third embodiment; and

FIG. 8 is a sequence diagram illustrating a relationship among a water heater, an external server, and another server according to the third embodiment.

### DETAILED DESCRIPTION OF THE PREFERRED EMBODIMENTS

Hereinafter, embodiments of the present disclosure will be described with reference to the accompanying drawings.

### First Embodiment

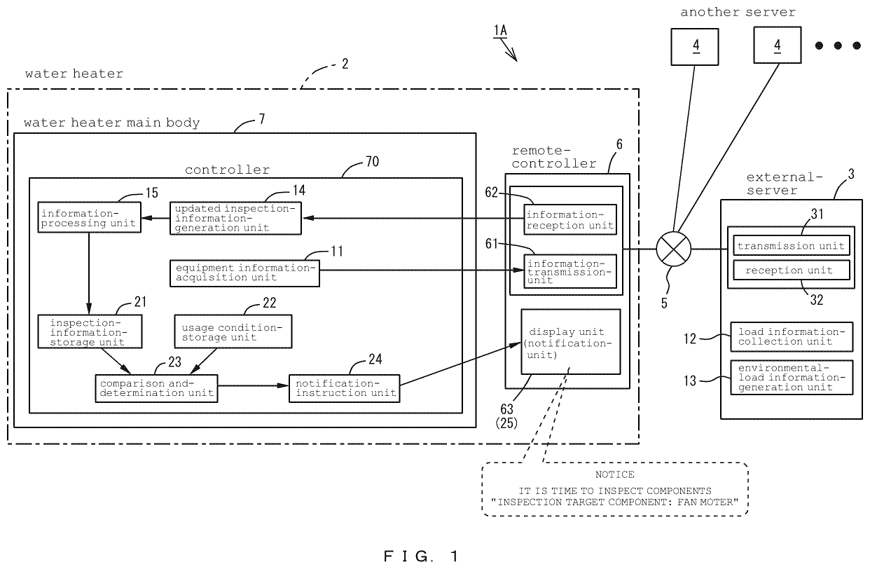

As illustrated in FIG. 1, a facility equipment cooperation system 1A of the first embodiment includes an external server 3 and a water heater (facility equipment) 2 communicably connected to the external server 3 via a network 5 such as an Internet line. The external server 3 is a computer including a control unit (a processor or the like), a storage device, a communication interface, and the like, and is connected to the water heater 2 via the network 5, and is also communicably connected to other servers 4 via the network 5. The external server 3 is, for example, a server of a manufacturer of the water heater 2. The water heater 2 has a function of performing an inspection notification for evoking a component inspection at a predetermined time based on determination from a usage condition of the component of the water heater 2 based on the inspection information. The present facility equipment cooperation system 1A is schematically configured such that the water heater 2 transmits installation place information regarding the installation place of the water heater 2 to the external server 3, the external server 3 collects load-related information regarding the environment of the installation place of the water heater 2 on the basis of the installation place information, and transmits external server information including information according to the installation environment of the water heater 2 to the water heater 2, and the water heater 2 updates the inspection information on the basis of the external server information.

In the present first embodiment, an example in which the present disclosure is applied to the gas water heater 2 as the facility equipment is shown. Here, the “facility equipment” of the present disclosure is facility equipment in which the life of the component of the facility equipment can be affected by the environment of the installation place, and includes residential equipment installed outdoors or indoors of a house, and facility equipment installed outdoors or indoors of various facilities such as an elderly facility. In addition to the gas water heater, the facility equipment includes a heat pump water heater, a hybrid water heater, a hot water storage tank water heater, an electric water heater, a hot water circulation heater, a dishwasher, a heating cooker, a fan heater, a clothes dryer, and the like.

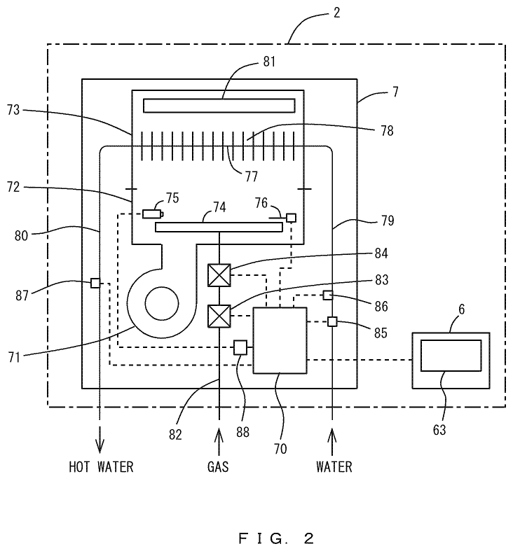

As illustrated in FIG. 2, the water heater 2 according to the first embodiment includes a water heater main body 7 and a remote controller 6. The water heater main body 7 includes a combustion unit 72 in which a fan 71 is connected to a bottom portion, and a heat exchange unit 73 connected to an upper portion of the combustion unit 72. The combustion unit 72 is provided with a burner 74 for burning mixed gas of fuel gas and primary air from the fan 71, an ignition electrode 75 for igniting the burner 74, and a frame rod 76 for detecting flame of the burner 74. The heat exchange unit 73 is provided with a fin tube type heat exchanger 78 that recovers heat in combustion exhaust gas from the burner 74 and heats water flowing in a heat transfer pipe 77. A water inflow pipe 79 is connected to the water inflow side of the heat transfer pipe 77, and a hot water outflow pipe 80 is connected to the water outflow side of the heat transfer pipe 77. An exhaust port 81 for exhausting combustion exhaust gas to the outside of the water heater main body 7 is provided in an upper portion of the heat exchange unit 73. A gas pipe 82 that supplies fuel gas to the burner 74 is provided with a main electromagnetic valve 83 and a gas proportional valve 84. The water inflow pipe 79 is provided with a water amount sensor 85 for detecting an amount of inflow water and a water inflow temperature sensor 86 for detecting a temperature of inflow water, and the hot water outflow pipe 80 is provided with a hot water outflow temperature sensor 87 for detecting a temperature of outflow hot water. As described above, the water heater 2 includes many components. These components may deteriorate and not function properly due to long-term use, and for example, it is recommended to inspect the water heater 2 for home use 10 years after manufacturing and the water heater 2 for business use 3 years after manufacturing.

A controller 70 that controls each operation of the water heater 2 is provided in the water heater main body 7. The controller 70 is constituted by a microcomputer (electronic unit) including a control unit (processor or the like), a storage device, and the like, and the above-described valves, sensors, and the like (76, 83 to 88, and the like) in the water heater 2 are electrically connected. The remote controller 6 for remotely operating the water heater 2 or the like is connected to the controller 70. The remote controller 6 has an external communication function that is communicably connected to the external server 3 via the network 5. Note that the remote controller 6 or the controller 70 may be configured to communicate with a communication device (repeater, smartphone, tablet, etc.), be connected to the network 5, and be communicably connected to the external server 3.

As an operation example of the operation of the water heater 2, when a hot water supply plug such as a faucet provided on the downstream side of the hot water outflow pipe 80 is opened, the controller 70 detects an operating water amount by a detection signal of the water amount sensor 85 and starts the operation of the water heater 2. When the operation of the water heater 2 is started, the fan 71 is operated to open the main electromagnetic valve 83 and the gas proportional valve 84 to supply fuel gas to the burner 74, and an igniter 88 is operated to generate spark discharge at the ignition electrode 75 to ignite the burner 74. After the ignition of the burner 74, the controller 70 adjusts the gas amount by the gas proportional valve 84 on the basis of the temperature of outflow hot water detected by the hot water outflow temperature sensor 87, the temperature of inflow water detected by the water inflow temperature sensor 86, and the set temperature set by the remote controller 6, and changes the rotational speed of the fan 71 according to the gas amount to control the temperature of outflow hot water to be the set temperature. Thereafter, when the hot water supply plug is closed, the controller 70 detects the operation stop water amount by the detection signal of the water amount sensor 85, closes the main electromagnetic valve 83 and the gas proportional valve 84 to extinguish the burner 74, and stops the fan 71 after performing the purge operation for a certain period of time to end the operation of the water heater 2.

Next, the inspection notification function of the water heater 2 will be described.

Referring to FIG. 1 again, the controller 70 of the water heater 2 includes an inspection information storage unit 21 that stores inspection information on the execution of an inspection of an inspection target component among a plurality of components constituting the water heater 2, a usage condition storage unit 22 that stores usage condition information on the usage condition of the inspection target component, a comparison and determination unit 23 that compares the inspection information stored in the inspection information storage unit 21 with the usage condition information stored in the usage condition storage unit 22 and determines whether or not the inspection notification time has come, and a notification instruction unit 24 that performs a notification instruction to a notification unit 25 to perform an inspection notification for evoking an inspection to a user when the comparison and determination unit 23 determines that the inspection notification time has come.

The inspection information storage unit 21 and the usage condition storage unit 22 are configured as functional units in a storage device of the controller 70, and the comparison and determination unit 23 and the notification instruction unit 24 are configured as functional units in a control unit of the controller 70. The notification unit 25 includes a display unit 63 of the remote controller 6 having a display function of displaying for evoking an inspection. Note that the notification unit 25 may include a speaker, a lamp, or the like of the remote controller 6 in addition to the display unit 63 of the remote controller 6.

The inspection information is information serving as a reference of an inspection time, and is information regarding an inspection usage time of a component, the number of times of inspection usage of a component, and the like. Regarding the execution of inspection, the inspection usage time is used as the inspection information for the components managed by the usage time, the number of times of inspection usage is used as the inspection information for the components managed by the number of usage times, and the inspection usage time and the number of times of inspection usage are used as the inspection information for the components managed by the usage time and the number of usage times. For example, in the case of the water heater 2, the execution of inspection of the fan motor of the fan 71, the burner 74, the sensors 85,86,87, and the like is managed by the usage time, and the execution of inspection of the igniter 88, the ignition electrode 75, the valves 83,84, and the like is managed by the number of usage times. The inspection usage time and the number of times of inspection usage are determined in advance on the basis of standard use conditions of the water heater 2, and for example, can be obtained by applying the lifetime and the durability in designing the component, or by being determined as about 90% of the lifetime and the durability. The inspection information storage unit 21 stores inspection information of at least one component as an inspection target component. Although the inspection information is stored in the inspection information storage unit 21 at the time of manufacturing the water heater 2, the inspection information may be read from a storage medium or a website dedicated to the installer of the manufacturer of the water heater 2 using a portable information terminal (PC, tablet, etc.) by the installer at the time of installing the water heater 2 and stored in the inspection information storage unit 21.

The usage condition information is information on the actual usage time of the inspection target component, the actual number of usage times of the inspection target component, and the like. The controller 70 includes a timer (not illustrated) that measures the usage time for each inspection target component. For example, the timer measures the time from when the controller 70 outputs the operation start signal to the inspection target component to when the controller outputs the operation stop signal, thereby acquiring the usage time of the inspection target component. The timer measures an operation time from the start to the end of operation of the water heater 2. In the inspection target component, for example, for a component such as a fan motor, a sensor, or a burner that can be regarded as being constantly operated during the operation of the water heater 2, the operation time of the water heater 2 may be used as the usage time of the inspection target component. In addition, the controller 70 includes a counter (not illustrated) that measures the number of usage times for each inspection target component. For example, the counter counts the number of times that the controller 70 has output the operation start signal to the inspection target component, thereby acquiring the number of usage times of the inspection target component.

The usage time of the inspection target component measured by the timer and the number of usage times of the inspection target component counted by the counter are stored in the usage condition storage unit 22 periodically or each time the operation of the water heater 2 is ended. In the usage condition storage unit 22, for each component, the usage time measured by the timer is stored as an accumulated usage time in which the usage time is accumulated, and the number of usage times measured by the counter is stored as an accumulated number of usage times in which the number of usage times is accumulated. The comparison and determination unit 23 compares the accumulated usage time (usage condition information) with the inspection usage time (inspection information) of the inspection target component, and compares the accumulated number of usage times (usage condition information) with the number of times of inspection usage (inspection information) of the inspection target component.

Next, an example of an operation of the inspection notification in the water heater 2 will be described.

The operation of the inspection notification is executed by the controller 70. From the start to the end of the operation of the water heater 2, the timer measures the usage time of the inspection target component. For example, the timer starts clocking by outputting an operation start signal from the controller 70 to the inspection target component, and stops clocking by outputting an operation stop signal, thereby measuring the usage time of the inspection target component.

Next, the usage time of the inspection target component measured by the timer is stored in the usage condition storage unit 22. The timing at which the usage time measured by the timer is stored in the usage condition storage unit 22 may be periodically executed such as a constant time every week (e.g., 7:00 AM on Monday) or a constant time every month (e.g., 7:00 AM on the first day), or may be executed every time the operation of the water heater 2 is ended. In the usage condition storage unit 22, the usage time of the inspection target component measured by the timer is added to the usage time already stored and stored as the accumulated usage time. The usage time of the inspection target component measured by the timer is reset when stored in the usage condition storage unit 22. The usage condition storage unit 22 stores the accumulated usage time corresponding to each inspection target component.

Next, when the usage time is newly stored in the usage condition storage unit 22, the comparison and determination unit 23 compares the inspection usage time (inspection information) of the inspection target component stored in the inspection information storage unit 21 with the accumulated usage time (usage condition information) of the inspection target component stored in the usage condition storage unit 22, and determines whether or not the inspection notification time of the inspection target component has come. Specifically, when a condition that the accumulated usage time of the inspection target component is equal to or longer than the inspection usage time of the inspection target component (usage condition information≥inspection information) is satisfied, it is determined that the inspection notification time of the inspection target component has come. When it is determined that the inspection notification time has come, the notification instruction unit 24 issues a notification instruction to the display unit 63 (notification unit 25) of the remote controller 6 to perform the inspection notification for the inspection target component. As a result, the display unit 63 of the remote controller 6 performs displaying for evoking an inspection of the inspection target component. As a display example of evoking an inspection, a title “notice”, a notification content “It is time to inspect components”, and a inspection target component “fan motor” are displayed. Note that the inspection notification may be a voice message or a buzzer by a speaker (notification unit 25) of the remote controller 6, blinking of a lamp (notification unit 25) of the remote controller 6, or the like. Then, the user recognizes the inspection notification and contacts the repair shop, and performs replacement, maintenance, maintenance, and the like of the inspection target component by the repair shop and ends the inspection work, the user resets the accumulated usage time stored in the usage condition storage unit 22 for the inspected component, and cancels the inspection notification of the display unit 63 of the remote controller 6.

In the operation example of the inspection notification, the inspection notification time is determined from the usage time of the inspection target component. However, depending on the type of the inspection target component, the inspection notification time may be determined from the number of usage times of the inspection target component, or the usage time and the number of usage times. In this case, too, it is assumed that the operation according to the procedure of the operation example is performed.

Next, a configuration related to the inspection notification of the facility equipment cooperation system 1A will be described.

As illustrated in FIG. 1, in the water heater 2, the controller 70 includes an equipment information acquisition unit 11 that acquires equipment information including installation place information regarding the installation place of the water heater 2, an updated inspection information generation unit 14 that generates updated inspection information for causing predetermined inspection information to be information according to the installation environment of the water heater 2 on the basis of the external server information transmitted from the external server 3, and an information processing unit 15 that updates the inspection information stored in the inspection information storage unit 21 to the updated inspection information generated by the updated inspection information generation unit 14. The equipment information acquisition unit 11, the updated inspection information generation unit 14, and the information processing unit 15 are configured as functional units in the control unit and the storage device of the controller 70.

In addition, the remote controller 6 includes, as a communication interface, an information transmission unit 61 that transmits the equipment information acquired by the equipment information acquisition unit 11 to the external server 3, and an information reception unit 62 that receives the external server information transmitted from the external server 3.

The equipment information includes product information on the water heater 2 and components in addition to the installation place information on the water heater 2. The product information is unique identification information on the water heater 2 and the components, and is, for example, information on a serial number, a model, and the like. The product information can be acquired by the equipment information acquisition unit 11 by reading the product information from the storage device of the controller 70 when the product information is stored in the storage device of the controller 70, or can be acquired by the user or the installer of the water heater 2 manually inputting the serial number, model, and the like described in the water heater 2 or the instruction manual from the remote controller 6 or a communication device (smartphone, tablet, etc.) communicable with the controller 70, or can be acquired by downloading the serial number, model, and the like from the home page for the user or the home page dedicated to the installer of the water heater 2 manufacturer.

The installation place information of the water heater 2 includes address information indicating an address or an area of a property (for example, a house) in which the water heater 2 is installed, and sensor information such as temperature, humidity, altitude, and illuminance detected by various sensors mounted on the water heater 2. Note that the “area” is an arbitrary range such as a block, a town, a school district, a municipality, or the like in the address place of the property. In the equipment information acquisition unit 11, when the controller 70 of the water heater 2 has the GPS function, the address information can be automatically acquired using the GPS, or can be acquired by manual input from the remote controller 6 or the communication device by the user or the installer of the water heater 2, or can be acquired by inputting the address information using the GPS function of the communication device by the user or the installer of the water heater 2.

The equipment information acquisition unit 11 acquires the sensor information from an output from each sensor of the water heater 2. Note that the equipment information acquisition unit 11 may aggregate and acquire information that changes daily, such as temperature, humidity, and illuminance, among the sensor information as an average value, a maximum value, a minimum value, or the like in a certain period such as year, month, week, or day.

The equipment information may include an installation date (Year, month and date of installation) and a manufacturing date (Year, month and date of manufacturing) of the water heater 2. That is, even when the water heater 2 is not used, if the installation area of the water heater 2 is, for example, in near the coast, the water heater 2 may be exposed to an air environment containing salt to accelerate the deterioration of the components, and it is preferable to include the installation date and the manufacturing date of the water heater 2 in the equipment information in order to know the installation period and the elapsed period after the manufacture of the water heater 2. The installation date of the water heater 2 can be acquired in the equipment information acquisition unit 11 by the installer or the user of the water heater 2 manually inputting the installation date from the remote controller 6 or the communication device, or can be automatically acquired at the time of trial operation when the water heater 2 is installed. When the manufacturing date of the water heater 2 is stored in the storage device of the controller 70, the manufacturing date can be read and acquired from the storage device of the controller 70, or the manufacturing date described in the water heater 2 or the instruction manual can be manually input by the user or the installer of the water heater 2 from the remote controller 6 or the communication device to cause the equipment information acquisition unit 11 to acquire the manufacturing date.

In the equipment information acquisition unit 11, since the product information, the address information, the installation date of the water heater 2, and the manufacturing date of the water heater 2 are determined when the water heater 2 is installed, these pieces of information are acquired when the water heater 2 is installed, and the sensor information is acquired constantly or at a certain timing.

The updated inspection information is inspection information obtained by reviewing predetermined inspection information using environmental load degree information included in the external server information to be described later. For example, in a case where the environmental load degree information is indicated by a predetermined constant, the updated inspection information is calculated by multiplying the predetermined inspection information by the constant which is the environmental load degree information, and the updated inspection information generation unit 14 generates the updated inspection information by performing the above calculation when the environmental load degree information is obtained from the external server 3. Then, when the updated inspection information generation unit 14 generates the updated inspection information, the information processing unit 15 performs processing of updating the inspection information stored in the inspection information storage unit 21 to the updated inspection information.

The external server 3 includes a load information collection unit 12 that collects load-related information related to the environment at the installation place of the water heater 2 on the basis of the installation place information included in the equipment information transmitted from the water heater 2, and an environmental load information generation unit 13 that generates environmental load degree information regarding evaluation of predetermined inspection information on the basis of the load-related information collected by the load information collection unit 12. The environmental load information generation unit 13 can generate the environmental load degree information in consideration of the sensor information included in the installation place information transmitted from the water heater 2 and the installation date and the manufacturing date of the water heater 2 included in the equipment information. The load information collection unit 12 and the environmental load information generation unit 13 are configured by a control unit of the external server 3 and a functional unit of the storage device.

The external server 3 includes, as a communication interface, a reception unit 32 that receives equipment information transmitted from the water heater 2, and a transmission unit 31 that transmits information including the environmental load degree information generated by the environmental load information generation unit 13 to the water heater 2 as external server information. Note that the external server 3 is also communicably connected to another server 4 via the network 5 by a communication interface (transmission unit 31, reception unit 32).

The load-related information is information serving as an environmental factor that can advance or delay the deterioration of the components of the water heater 2 more than the lifetime or the durability in design, and is environmental data such as weather data and geographical data in the installation place of the water heater 2.

The weather data is, for example, weather information such as temperature, humidity, sunshine hours, precipitation amount, and the like in the area where the water heater 2 is installed, and is an average value, a maximum value, a minimum value, and the like of the weather information for a certain period such as year, month, week, or day. In addition, the weather data may include the number of extremely hot days, the number of typhoons, the number of tornado generations, and the like in an area where the water heater 2 is installed. In a case where the water heater 2 is installed in an area where such weather data is higher or larger than a certain level, it is considered that the component lifetime is shortened with respect to the component of the water heater 2.

The geographical data is, for example, geographical information indicating whether or not the address place of the property at the installation place of the water heater 2 corresponds to near a coast (for example, an area within 1000 m from the coastline), a high altitude of 1000 m or more above sea level, a high hardness water region, a region where a lot of volcanic ash falls, or the like. In a case where the water heater 2 is installed in an area corresponding to such geographic data, it is considered that the component lifetime is shortened with respect to the component of the water heater 2.

In the load information collection unit 12, the external server 3 can collect weather data by accessing a homepage or the like of the Meteorological Agency (including public or private organizations that hold weather data) which is another server 4. In addition, in the load information collection unit 12, the external server 3 can collect geographical data by accessing a homepage or the like of the Geographical Survey Institute, the Waterworks Bureau, or the like (including public or private organizations that hold geographic data), which is another server 4.

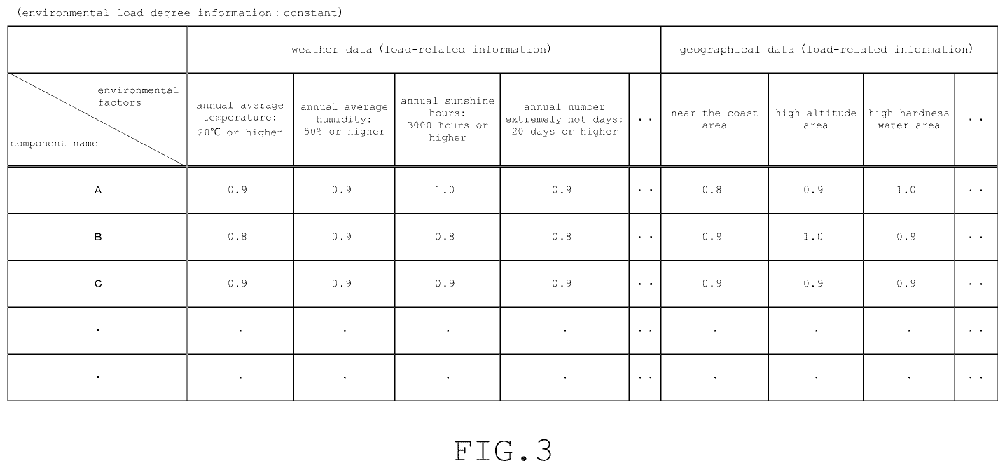

The environmental load degree information is evaluation information for evaluating predetermined inspection information on the basis of the load-related information and also in consideration of the sensor information included in the installation place information and the installation date and the manufacturing date of the water heater 2 included in the equipment information, and is indicated by a constant, for example. The constant serving as the environmental load degree information is determined for each component for each environmental factor of the weather data and the geographic data serving as the load-related information, and can be determined on the basis of an experimental result, a result of calculation, artificial intelligence (AI), or the like. The constant to be the environmental load degree information can be collected as tabular data such as a table illustrated in FIG. 3, for example. The environmental load information generation unit 13 has, for example, the table illustrated in FIG. 3, and collates each environmental factor of the load-related information at the installation place of the water heater 2 and each component of the water heater 2 with the table illustrated in FIG. 3 to determine a constant to be the environmental load degree information for each component. As an example, for a specific fan motor, if the installation place of the water heater 2 is near the coast (the environmental factor of the load-related information), the constant to be the environmental load degree information is defined as “0.8”. When the installation environment of the water heater 2 corresponds to a plurality of environmental factors of the load-related information, the lowest constant is assigned as the constant to be the environmental load degree information. For example, in the environmental factor of the load-related information, when the installation place of the water heater 2 is near the coast and corresponds to the area with the annual average temperature of 20° C. or higher, and when the constant of the environmental load degree information as near the coast is defined as “0.8”, and the constant of the environmental load degree information as the area with the annual average temperature of 20° C. or higher is defined as “0.9” for a predetermined fan motor, “0.8” which is the lowest constant is assigned as the constant of the environmental load degree information for the fan motor.

Next, an operation of the facility equipment cooperation system 1A will be described.

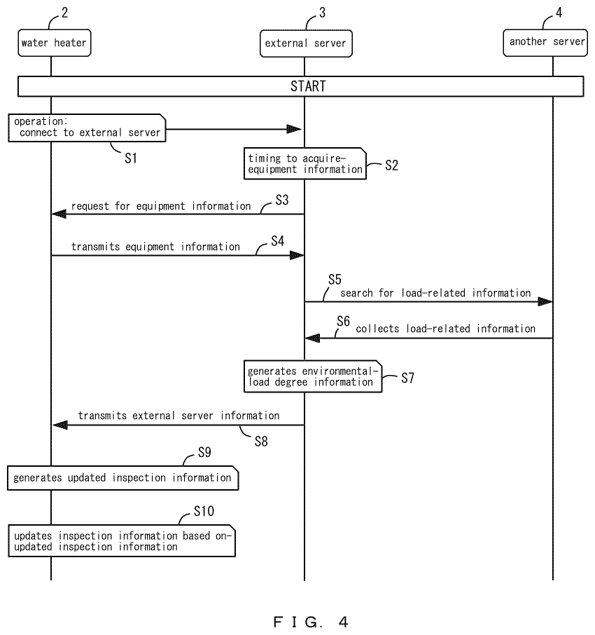

This operation is an operation in which the water heater 2 and the external server 3 cooperate to update the inspection information according to the installation environment of the water heater 2. The operation of the water heater 2 described below is executed by the controller 70 of the water heater 2 and the remote controller 6. FIG. 4 is a sequence diagram illustrating a relationship among the water heater 2, the external server 3, and another server 4 (a weather data providing website or the like), and the operation of the facility equipment cooperation system 1A will be described with reference to FIG. 4.

In step S1, the water heater 2 is communicably connected to the external server 3 via the network 5 periodically, for example, once a day.

In step S2, when the external server 3 is communicably connected to the water heater 2, the external server 3 recognizes that it is timing to acquire equipment information for the water heater 2.

In step S3, the external server 3 transmits a request signal for requesting the water heater 2 to transmit the equipment information.

In step S4, in response to the request signal from the external server 3, the water heater 2 transmits the equipment information including the installation place information of the water heater 2 acquired by the equipment information acquisition unit 11 to the external server 3.

In steps S5 and S6, the external server 3 accesses another server 4 on the basis of the installation place information included in the equipment information received from the water heater 2, and the load information collection unit 12 collects load-related information that is weather data such as temperature in the installation area of the water heater 2 and geographic data such as whether or not the area is near the coast.

In step S7, in the external server 3, the environmental load information generation unit 13 generates the environmental load degree information related to the evaluation of the inspection information predetermined for each component of the water heater 2, on the basis of the load-related information collected by the load information collection unit 12 and also in consideration of the sensor information included in the installation place information received from the water heater 2 and the installation date and the manufacturing date of the water heater 2 included in the equipment information.

In step S8, the external server 3 transmits the external server information including the environmental load degree information generated by the environmental load information generation unit 13 to the water heater 2.

In step S9, in the water heater 2, the updated inspection information generation unit 14 generates the updated inspection information according to the installation environment of the water heater 2 on the basis of the environmental load degree information included in the external server information transmitted from the external server 3.

In step S10, in the water heater 2, the information processing unit 15 updates the inspection information stored in the inspection information storage unit 21 to the updated inspection information generated by the updated inspection information generation unit 14.

The equipment information transmitted from the water heater 2 to the external server 3 and the external server information transmitted from the external server 3 to the water heater 2 include an identifier (ID) for specifying the water heater 2.

With the above operation, the inspection information is updated to the updated inspection information, whereby the reference of the inspection notification time is changed to a new reference in consideration of the installation environment of the water heater 2. For example, for a specific fan motor as an inspection target component, when the constant to be the environmental load degree information is “0.8”, the inspection usage time of the fan motor (predetermined inspection information) is changed from 1000 hours to 800 hours (updated inspection information) that is 0.8 times (environmental load degree information).

In this way, after the inspection information is updated to the updated inspection information, the comparison and determination unit 23 compares the updated inspection information with the usage condition information to determine whether or not the inspection notification time has come. In a case where the comparison and determination unit 23 determines that the inspection notification time has come, the notification instruction unit 24 issues a notification instruction to the notification unit 25, and the notification unit 25 performs an inspection notification for evoking the inspection to the user. That is, the inspection information is updated to the updated inspection information in consideration of the installation environment of the water heater 2, whereby the inspection notification time is changed to a time corresponding to the installation environment of the water heater 2. The water heater 2 periodically communicates with the external server 3 to update the inspection information, so that the inspection reference can be reviewed in response to a change in the installation environment of the water heater 2. Therefore, the inspection notification can be performed at a time reflecting the actual situation of the installation environment of the water heater 2. Therefore, according to the facility equipment cooperation system 1A of the first embodiment, even when the water heater 2 is installed in an installation environment in which the lifetime of component is shortened, it is possible to perform an inspection notification to the user at an appropriate time according to the installation environment of the water heater 2. In addition, even when the water heater 2 is installed in an installation environment where the lifetime of the component is prolonged, the inspection notification is not performed at an unnecessarily early time. Therefore, it is possible to take measures such as replacement, maintenance, and maintenance of the component at an appropriate time before the end of the component life in consideration of the installation environment of the water heater 2, thereby preventing the water heater 2 from becoming unable to supply hot water due to the end of the component life.

In the external server 3, the load information collection unit 12 collects the load-related information as the environmental data (weather data, geographic data, etc.) at the installation place of the water heater 2 from the enormous data, and the environmental load information generation unit 13 generates the environmental load degree information. Therefore, the load of the processing for the inspection notification by the controller 70 of the water heater 2 can be reduced, and accordingly, the capacity of the microcomputer in the controller 70 of the water heater 2 can be made relatively small, and the cost of the water heater 2 can be suppressed.

In step S8, the external server 3 includes the environmental load degree information (for example, a constant) in the external server information and transmits the information to the water heater 2 to which the equipment information has been transmitted. Alternatively, the external server 3 may transmit the same environmental load degree information to all the water heaters of the same type installed in the area where the water heater 2 is installed, in addition to the water heater 2. As a result, in all the water heaters in the specific area, the inspection information can be simultaneously updated, and the inspection notification can be performed at an appropriate time according to the environment of the specific area.

### Second Embodiment

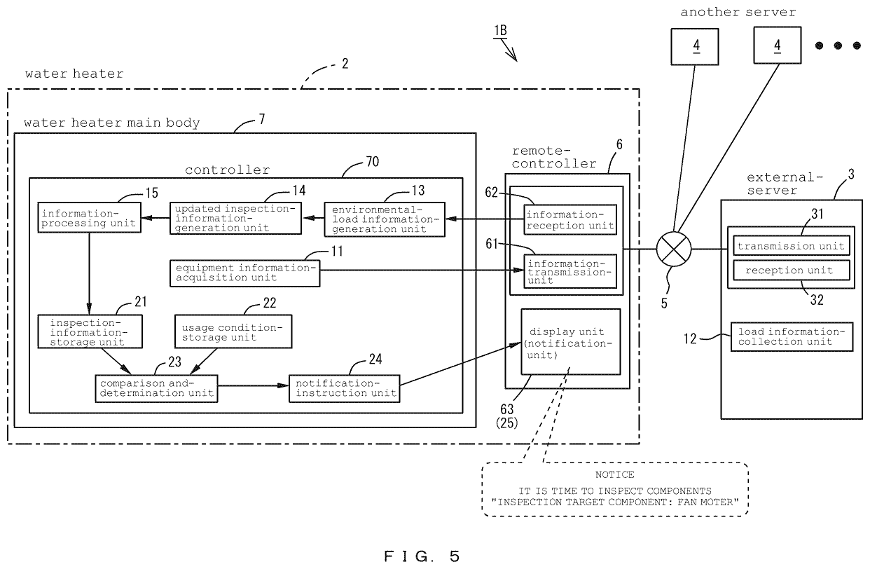

A facility equipment cooperation system 1B of the second embodiment is different from the facility equipment cooperation system 1A of the first embodiment in that the environmental load information generation unit 13 is provided on the side of the water heater 2 which is the facility equipment. As illustrated in FIG. 5, in the facility equipment cooperation system 1B according to the second embodiment, the external server 3 includes a load information collection unit 12 as a configuration related to the update of the inspection information, and the controller 70 of the water heater 2 includes an equipment information acquisition unit 11, an environmental load information generation unit 13, an updated inspection information generation unit 14, and an information processing unit 15.

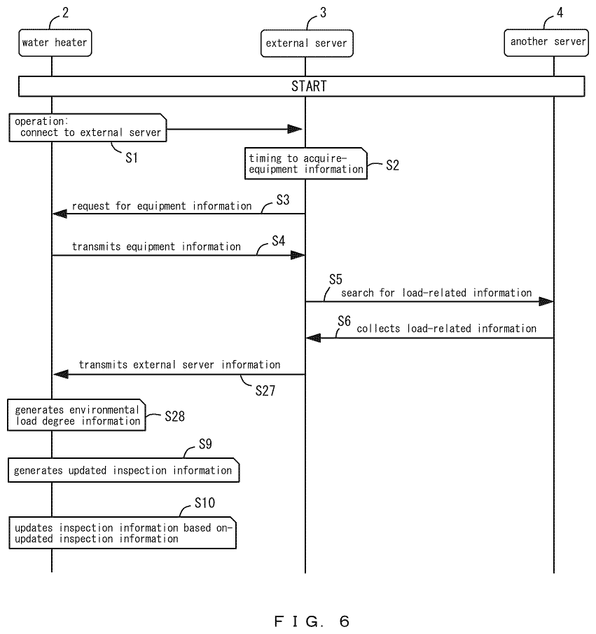

In the operation in which the water heater 2 and the external server 3 cooperate with each other in the facility equipment cooperation system 1B of the second embodiment, as illustrated in FIG. 6, when the load information collection unit 12 collects the load-related information in the installation area of the water heater 2 (steps S5 and S6), the external server 3 transmits the external server information including the load-related information to the water heater 2 (step S27). When the water heater 2 receives the external server information, the environmental load information generation unit 13 generates environmental load degree information regarding evaluation of inspection information predetermined for each component of the water heater 2 on the basis of the load-related information included in the external server information (step S28). Then, in the water heater 2, the updated inspection information generation unit 14 generates updated inspection information according to the installation environment of the water heater 2 on the basis of the environmental load degree information generated by the environmental load information generation unit 13 (step S9), and the information processing unit 15 updates the inspection information stored in the inspection information storage unit 21 to the updated inspection information generated by the updated inspection information generation unit 14 (step S10).

According to the facility equipment cooperation system 1B of the second embodiment, in the external server 3, the load information collection unit 12 collects the load-related information including the environmental data in the installation place of the water heater 2 from the enormous data, so that the load of the processing for the inspection notification by the controller 70 of the water heater 2 can be reduced, and accordingly, the capacity of the microcomputer in the controller 70 of the water heater 2 can be made relatively small, and the cost of the water heater 2 can be suppressed. In the second embodiment, by providing the environmental load information generation unit 13 on the water heater 2 side, it is possible to reduce the storage capacity corresponding to the environmental load information generation unit 13 and the load of calculation processing in the external server 3. Note that the second embodiment is similar to or corresponds to the first embodiment except for the configuration, operation, and effect described above.

### Third Embodiment

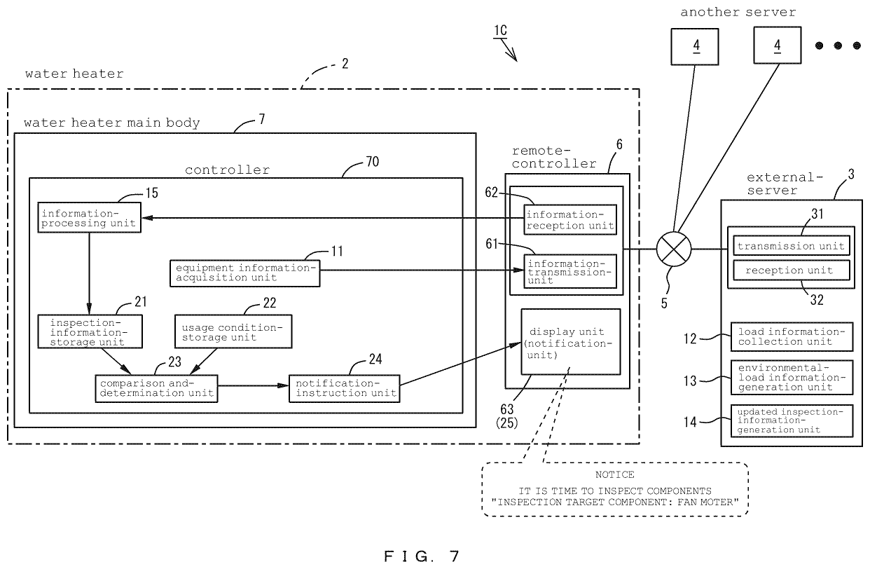

A facility equipment cooperation system 1C of the third embodiment is different from the facility equipment cooperation system 1A of the first embodiment in that the updated inspection information generation unit 14 is provided on the external server 3 side. As illustrated in FIG. 7, in the facility equipment cooperation system 1C according to the third embodiment, as a configuration related to update of the inspection information, the external server 3 includes a load information collection unit 12, an environmental load information generation unit 13, and an updated inspection information generation unit 14, and the controller 70 of the water heater 2 includes an equipment information acquisition unit 11 and an information processing unit 15.

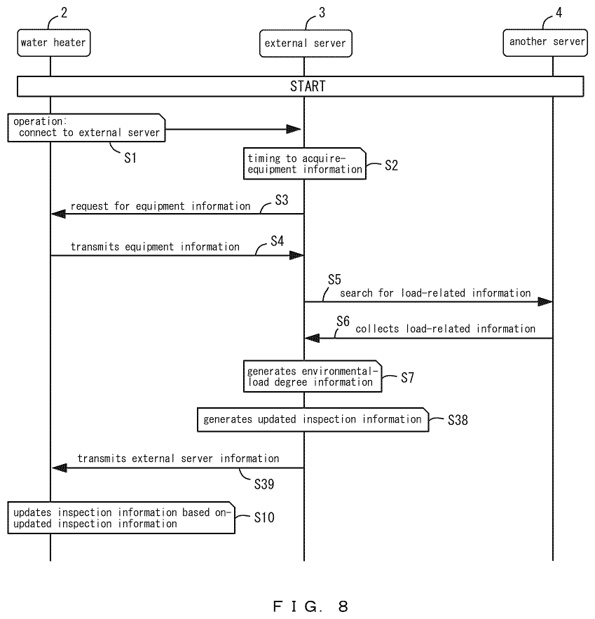

In the operation in which the water heater 2 and the external server 3 cooperate with each other in the facility equipment cooperation system 1C of the third embodiment, as illustrated in FIG. 8, in the external server 3, when the environmental load information generation unit 13 generates the environmental load degree information (step S7), the updated inspection information generation unit 14 generates the updated inspection information according to the installation environment of the water heater 2 on the basis of the environmental load degree information generated by the environmental load information generation unit 13 (step S38). Subsequently, the external server 3 transmits external server information including the updated inspection information generated by the updated inspection information generation unit 14 to the water heater 2 (step S39). When the water heater 2 receives the external server information, the information processing unit 15 updates the inspection information stored in the inspection information storage unit 21 to the updated inspection information included in the external server information (step S10).

According to the facility equipment cooperation system 1C of the third embodiment, in the external server 3, the load information collection unit 12 collects the load-related information including the environmental data in the installation place of the water heater 2 from the enormous data, the environmental load information generation unit 13 generates the environmental load degree information, and the updated inspection information generation unit 14 generates the updated inspection information. Therefore, the load of the processing for the inspection notification by the controller 70 of the water heater 2 can be reduced, and accordingly, the capacity of the microcomputer in the controller 70 of the water heater 2 can be made relatively small, and the cost of the water heater 2 can be suppressed. Note that the third embodiment is similar to or corresponds to the first embodiment except for the configuration, operation, and effect described above.

Note that the present disclosure is not limited to the above embodiments, and various modifications can be made within the scope of claims.

For example, the load information collection unit 12 can be provided on the external server 3 side, the equipment information acquisition unit 11 and the information processing unit 15 can be provided on the facility equipment 2 side, and both or one of the environmental load information generation unit 13 and the updated inspection information generation unit 14 can be provided on the external server 3 side or the facility equipment 2 side.

The information transmission unit 61, the information reception unit 62, and the display unit 63 (the notification unit 25) included in the remote controller 6 in each of the above embodiments may be provided in the equipment body 7 of the facility equipment 2, and the facility equipment 2 may not include the remote controller.

In addition, a communication device (smartphone, tablet, etc.) communicably connected to the external server 3 via the network 5 may be configured to include some configurations (equipment information acquisition unit 11, information processing unit 15, and optionally, environmental load information generation unit 13, and updated inspection information generation unit 14) of the present facility equipment cooperation system 1 in the dedicated application program. In this case, the communication device is communicably connected to the controller 70 or the remote controller of the facility equipment 2 directly or via a repeater or the like, and is a part of the configuration of the facility equipment 2 in the facility equipment cooperation system 1.

Furthermore, a display unit of a portable information terminal such as a smartphone or a tablet owned by the user may be configured to function as the notification unit 25 by a dedicated application program.

What is claimed is:

1. A facility equipment cooperation system comprising:
an external server; and
facility equipment capable of communicating with the external server,
wherein the external server is configured to transmit external server information including information according to an installation environment of the facility equipment to the facility equipment on a basis of equipment information transmitted from the facility equipment,
the facility equipment includes:
an inspection information storage unit corresponding to at least one component of a plurality of components constituting the facility equipment and storing inspection information regarding execution of a predetermined inspection;
a usage condition storage unit that stores usage condition information on a usage condition of the one component or the facility equipment;
a comparison and determination unit that compares the inspection information stored in the inspection information storage unit with the usage condition information stored in the usage condition storage unit and determines whether or not an inspection notification time has come;
a notification instruction unit that performs a notification instruction to a notification unit that performs an inspection notification for evoking an inspection to a user when the comparison and determination unit determines that the inspection notification time has come;
an equipment information acquisition unit that acquires the equipment information including installation place information regarding an installation place of the facility equipment;
an information transmission unit that transmits the equipment information acquired by the equipment information acquisition unit to the external server;
an information reception unit that receives the external server information transmitted from the external server; and
an information processing unit that updates the inspection information stored in the inspection information storage unit on a basis of the external server information received by the information reception unit, and
the comparison and determination unit is configured to compare, after the inspection information of the inspection information storage unit is updated, the updated inspection information with the usage condition information, and determine whether or not the inspection notification time has come.

2. The facility equipment cooperation system according to claim 1, wherein
the external server includes:
a load information collection unit that collects load-related information regarding an environment in an installation place of the facility equipment on a basis of the installation place information included in the equipment information transmitted from the facility equipment; and
an environmental load information generation unit that generates environmental load degree information regarding evaluation of the predetermined inspection information on a basis of the load-related information collected by the load information collection unit,
the external server transmits information including the environmental load degree information to the facility equipment as the external server information,
the facility equipment includes an updated inspection information generation unit that generates updated inspection information in which the predetermined inspection information is information according to an installation environment of the facility equipment on a basis of the environmental load degree information included in the external server information received by the information reception unit, and
the information processing unit updates the inspection information stored in the inspection information storage unit to the updated inspection information.

3. The facility equipment cooperation system according to claim 1, wherein
the external server includes a load information collection unit that collects load-related information regarding an environment in an installation place of the facility equipment on a basis of the installation place information included in the equipment information transmitted from the facility equipment,
the external server transmits information including the load-related information to the facility equipment as the external server information,
the facility equipment includes:
an environmental load information generation unit that generates environmental load degree information regarding evaluation of the predetermined inspection information on a basis of the load-related information included in the external server information received by the information reception unit; and
an updated inspection information generation unit that generates updated inspection information in which the predetermined inspection information is information according to an installation environment of the facility equipment on a basis of the environmental load degree information, and
the information processing unit updates the inspection information stored in the inspection information storage unit to the updated inspection information.

4. The facility equipment cooperation system according to claim 1, wherein
the external server includes:
a load information collection unit that collects load-related information regarding an environment in an installation place of the facility equipment on a basis of the installation place information included in the equipment information transmitted from the facility equipment;
an environmental load information generation unit that generates environmental load degree information regarding evaluation of the predetermined inspection information on a basis of the load-related information collected by the load information collection unit; and
an updated inspection information generation unit that generates updated inspection information in which the predetermined inspection information is information according to an installation environment of the facility equipment on a basis of the environmental load degree information generated by the environmental load information generation unit,
the external server transmits information including the updated inspection information to the facility equipment as the external server information, and
the information processing unit of the facility equipment updates the inspection information stored in the inspection information storage unit with the updated inspection information included in the external server information received by the information reception unit.
